(19) United States
(12) Patent Application Publication
(10) Pub. No.: US 2012/0087573 A1
(43) Pub. Date: Apr. 12, 2012

(54) Eliminating Clutter in Video Using Depth Information

(76) Inventors: Vinay Sharma, Dallas, TX (US); Goksel Dedeoglu, Plano, TX (US); Bruce Edward Flinchbaugh, Dallas, TX (US)

(21) Appl. No.: 13/271,019

(22) Filed: Oct. 11, 2011

Related U.S. Application Data
(60) Provisional application No. 61/391,916, filed on Oct. 11, 2010.

(51) Int. Cl. G06K 9/34

(52) U.S. Cl. 382/154

(57) ABSTRACT

A method of clutter elimination in digital images is provided that includes identifying a foreground blob in an image, determining a depth of the foreground blob, and indicating that the foreground blob is clutter when the depth indicates that the foreground blob is too close to be an object of interest. Methods for obstruction detection in depth images such as those captured by stereoscopic cameras and structured light cameras are also provided.

### CROSS-REFERENCE TO RELATED APPLICATIONS

This application claims benefit of U.S. Provisional Patent Application Ser. No. 61/391,916, filed Oct. 11, 2010, which is incorporated by reference herein in its entirety.

### BACKGROUND OF THE INVENTION

1. Field of the Invention

Embodiments of the present invention generally relate to elimination of clutter and obstruction detection in video using depth information.

2. Description of the Related Art

In video surveillance, most applications begin by segmenting foreground objects/blobs in the scene. The foreground blobs typically correspond to moving foreground objects, e.g., people, vehicles, etc., and the temporal and spatial properties of such blobs are analyzed to recover useful information about them. In such surveillance applications, environmental artifacts such as snowflakes, rain drops, or flying insects or other items accidentally or purposefully placed in close proximity to a camera tend to be segmented as foreground blobs, causing many false alarms.

### SUMMARY

Embodiments of the present invention relate to methods for clutter elimination and obstruction detection in depth images. A method of clutter elimination is provided that includes identifying a foreground blob in an image, determining a depth of the foreground blob, and indicating that the foreground blob is clutter when the depth indicates that the foreground blob is too close to be an object of interest. Methods for obstruction detection in depth images such as those captured by stereoscopic cameras and structured light cameras are also provided.

### BRIEF DESCRIPTION OF THE DRAWINGS

Particular embodiments in accordance with the invention will now be described, by way of example only, and with reference to the accompanying drawings:

FIGS. 1A, 1B, and 2 are examples illustrating the effect of environmental artifacts in a video surveillance system;

FIG. 3 is a block diagram of a surveillance system;

FIG. 4 is a block diagram of a 3D digital video camera;

FIG. 5 is a block diagram of a computer;

FIGS. 6-9 are flow diagrams of methods; and

FIGS. 10A-10C and 11 are examples.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

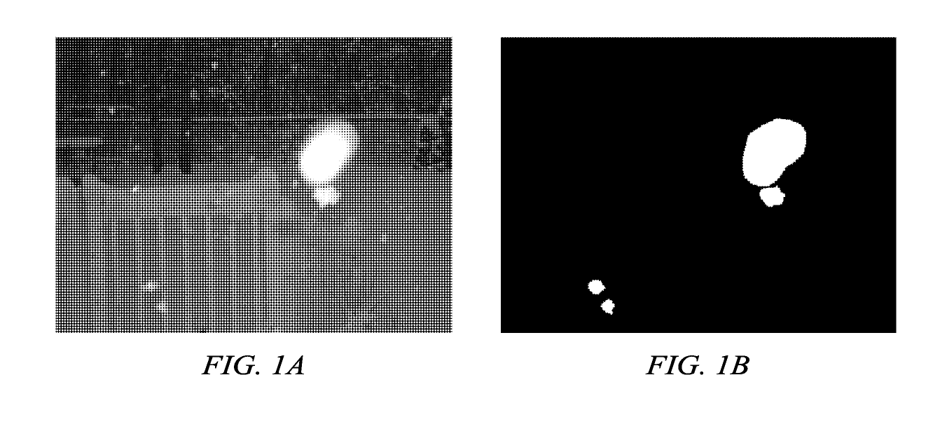

FIG. 1A shows an example two-dimensional (2D) image in which snowflakes are falling in close proximity to the camera and FIG. 1B shows the typical foreground blobs generated by a background-subtraction technique applied to the image. The blobs corresponding to the snowflakes are sufficiently large to be mistaken for an object of interest in the scene such as a person or a vehicle. Reliably determining that the large blob in FIG. 1B was caused by a snowflake close to the camera and not by a larger object located further away from the lens is difficult. Such an assertion is typically obtained only after computationally expensive processing and is rarely possible without temporal analysis.

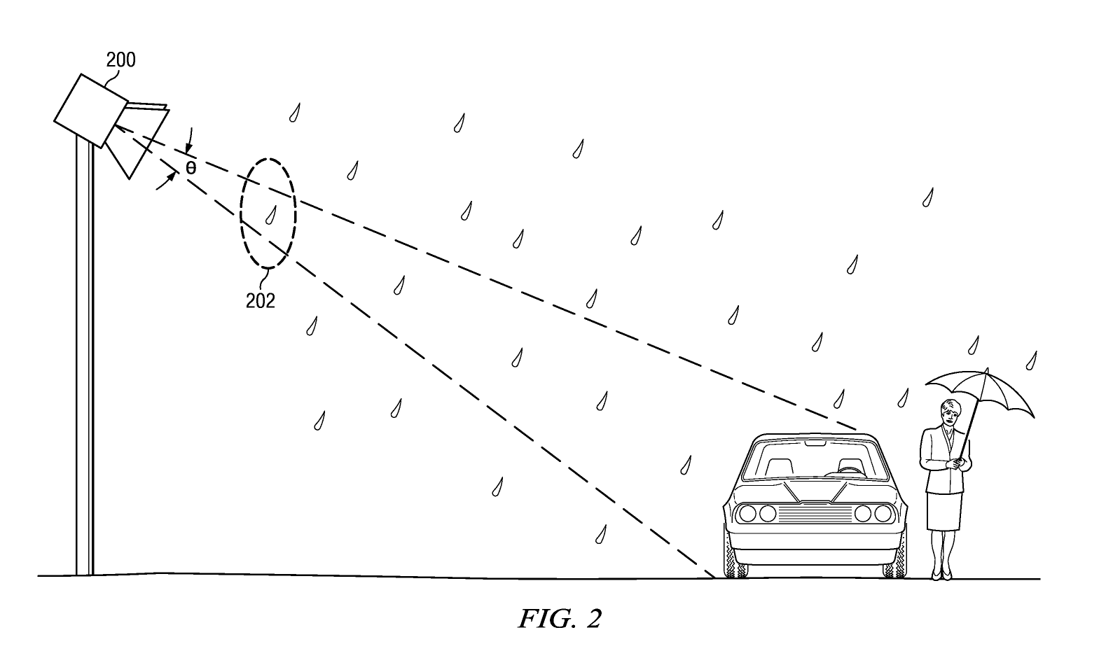

FIG. 2 is another example illustrating the impact of environmental artifacts when surveilling a scene. When a camera is pointed at a scene, all objects in the scene subtend an angle on the image sensor. In the scene of FIG. 2, the angle θ subtended by the car on the sensor of the 2D surveillance camera 200 is the same as that of the raindrop 202 much closer to the surveillance camera 200. Typical 2D segmentation algorithms may have difficulty ignoring the raindrop 202 as it will appear to be the same size as an object of interest, i.e., the car.

Embodiments of the invention provide for elimination of clutter in images captured by a 3D surveillance camera by using depth information. Clutter may occur in a scene due to environmental artifacts such as rain drops, snowflakes, ice, or insects coming too close to the camera and/or due to accidental or purposeful insertion of objects in close proximity to the camera. In essence, clutter may be any object that is too close to the camera to be an object of interest in the scene. More specifically, in one or more embodiments, foreground blobs are identified in a 3D image of the scene under surveillance. The depth of each identified foreground blob is determined using depth information corresponding to one or more pixels in the blob. This depth is used to determine if the blob is too close to the camera to be an object of interest. If a blob is determined to be too close to the camera, the blob is marked as clutter. The remaining foreground blobs are processed normally.

In some embodiments, at least one 2D image and a 3D image of the scene under surveillance are used to identify clutter. In such embodiments, foreground blobs are identified in the 2D image. Then, for each blob, relevant features are extracted and compared to relevant features of objects of interest. If the blob features are sufficiently similar to the features of an object of interest, the blob is processed normally. If the blob features are not sufficiently similar to an object of interest, the depth of the blob is determined from the depth information corresponding to one or more pixels of the blob in the 3D image. The depth is used to determine if the blob is too close to the camera to be an object of interest. If the blob is determined to be too close to the camera, the blob is marked as clutter. Otherwise, the blob will be processed normally. Normal processing may include, for example, classification of the blob, and/or tracking of the blob, comparison against a database of expected objects.

In some embodiments, obstruction detection may also be performed in addition to elimination of clutter. In some such embodiments, foreground blobs are identified in each of the left 2D image and the right 2D image of a stereoscopic image of the scene under surveillance. The foreground blobs in the two images are then matched. If all blobs are matched, then clutter detection is performed on the stereoscopic image. If one or more of the blobs does not have a match, then the view of one of the lenses used to capture that image is considered to be obstructed. For example, an insect may have obstructed one lens, introducing an extra blob into the image captured by the corresponding imaging sensor that does not appear in the image captured by the other imaging sensor. The image with the missing blob(s) is identified, and 2D video analysis is performed on the identified image. In addition, confidence in the depth computation for the stereoscopic image may be decreased and presence of an obstruction may be signaled.

In some such embodiments, structured light codewords are detected in a depth image captured by a structured light camera based on the projected light pattern. If the number of valid codewords is not higher than a threshold, then either the lens or the light projector of the camera is considered to be obstructed. Confidence in the depth computation of the depth image may be decreased and presence of an obstruction may be signaled.

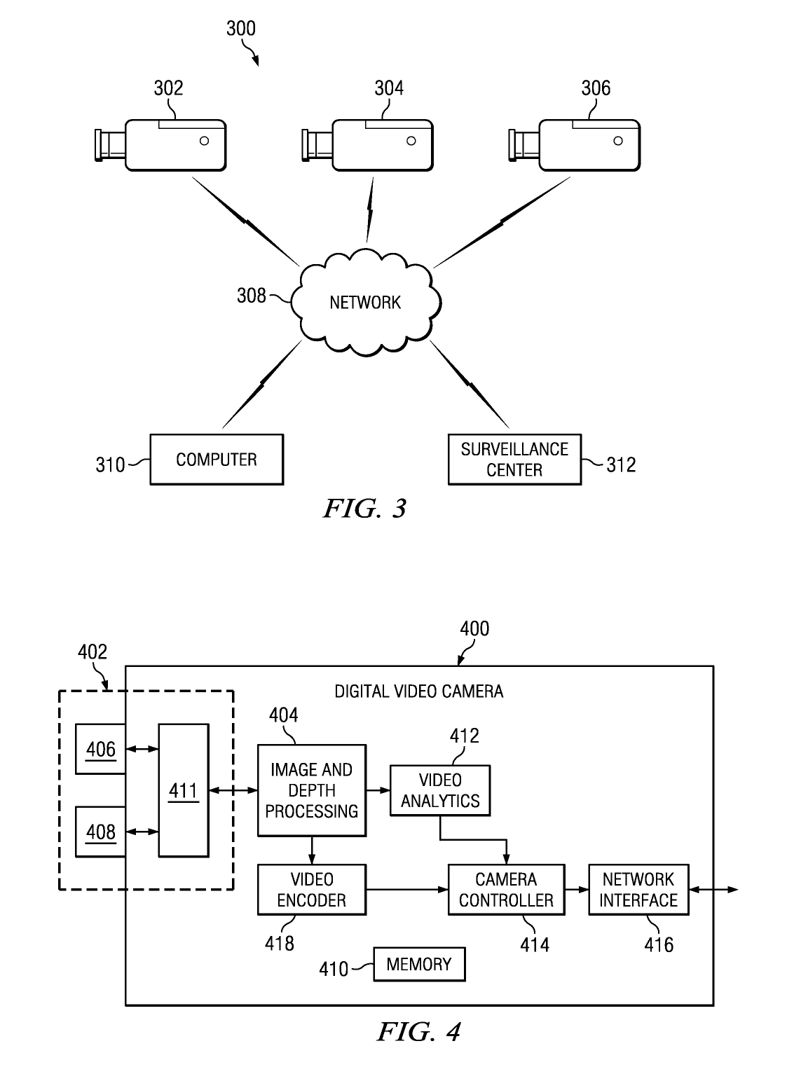

FIG. 3 is a block diagram of an example surveillance network 300. The surveillance network 300 includes three video surveillance cameras 302, 304, 306, and two monitoring systems 310, 312 connected via a network 308. The network 308 may be any communication medium, or combination of communication media suitable for transmission of video sequences captured by the surveillance cameras 302, 304, 306, such as, for example, wired or wireless communication media, a local area network, or a wide area network.

Three surveillance cameras are shown for illustrative purposes. More or fewer surveillance cameras may be used. Each of the surveillance cameras 302, 304, 308 includes functionality to capture depth images of a scene. A depth image, which may also be referred to as a 3D image, is a two-dimensional array where the x and y coordinates correspond to the rows and columns of the pixel array as in a 2D image, and the corresponding depth values (z values) of the pixels are stored in the array's elements. These depth values are distance measurements from the camera to the corresponding surface points on objects in the scene.

A camera with functionality to capture depth images of a scene may be referred to as a 3D camera or depth camera. Examples of depth cameras include stereoscopic cameras, structured light cameras, and time-of-flight (TOF) cameras. Other 3D imaging technology may also be used. In general, a stereoscopic camera performs stereo imaging in which 2D images from two (or more) passive image sensors are used to determine a depth image from disparity measurements between the 2D images. In general, a structured light camera projects a known pattern of light onto a scene and analyzes the deformation of the pattern from striking the surfaces of objects in the scene to determine the depth. In general, a TOF camera emits light pulses into the scene and measures the time between an emitted light pulse and the corresponding incoming light pulse to determine scene depth. Depth cameras such as structured light camera and TOF cameras may also incorporate additional imaging sensors to generate a 2D grayscale or color image of the scene in addition to the depth image.

The surveillance cameras 302, 304, 308 may be stationary, may pan a surveilled area, or a combination thereof. The surveillance cameras may include functionality for encoding and transmitting video sequences to a monitoring system 310, 312 or may be connected to a system (not specifically shown) that provides the encoding and/or transmission. Although not specifically shown, one or more of the surveillance cameras 302, 304, 306 may be directly connected to a monitoring system 310, 312 via a wired interface instead of via the network 308.

Different monitoring systems 310, 312 are shown to provide examples of the types of systems that may be connected to surveillance cameras. One or ordinary skill in the art will know that the surveillance cameras in a network do not necessarily communicate with all monitoring systems in the network. Rather, each surveillance camera will likely be communicatively coupled with a specific computer 310 or surveillance center 312.

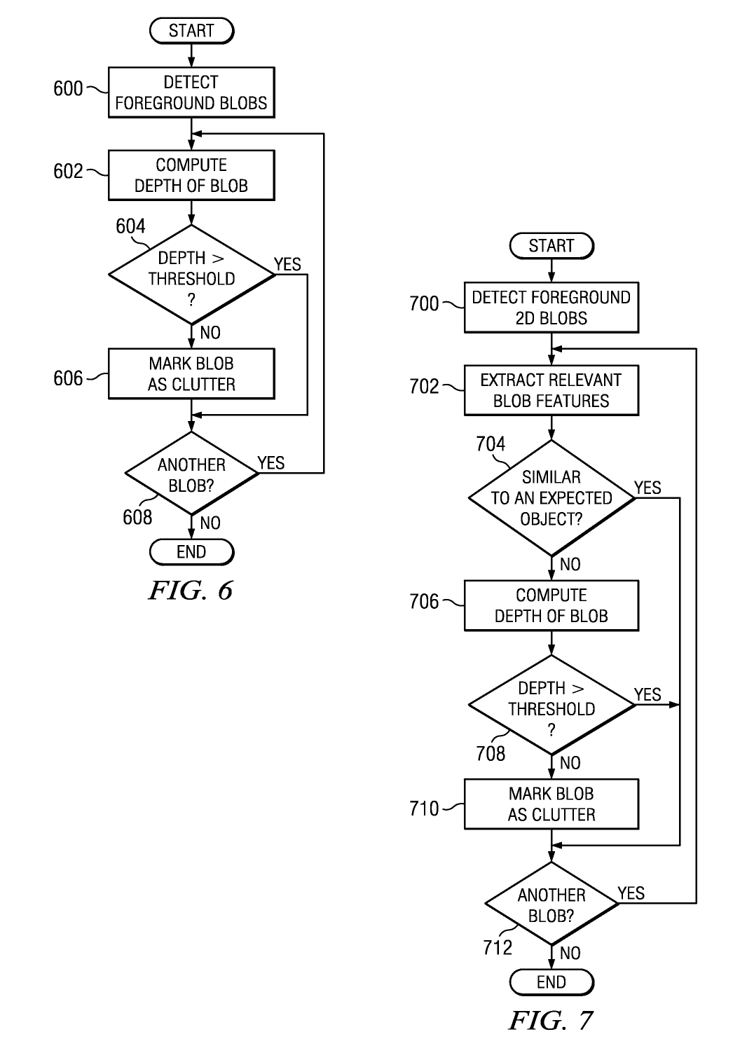

In one or more embodiments, the surveillance network 300 includes functionality to eliminate clutter in the 3D images captured by the surveillance cameras. Methods for elimination of clutter are described in more detail herein in reference to FIGS. 6 and 7. Clutter elimination may be performed in a suitably configured surveillance camera, or in a suitably configured computer in the surveillance center 312 that is receiving encoded video sequence from a surveillance camera or in a computer 310. The clutter elimination may also be provided by a system (not specifically shown) connected to a surveillance camera that provides the encoding and/or transmission of video sequences captured by the surveillance camera.

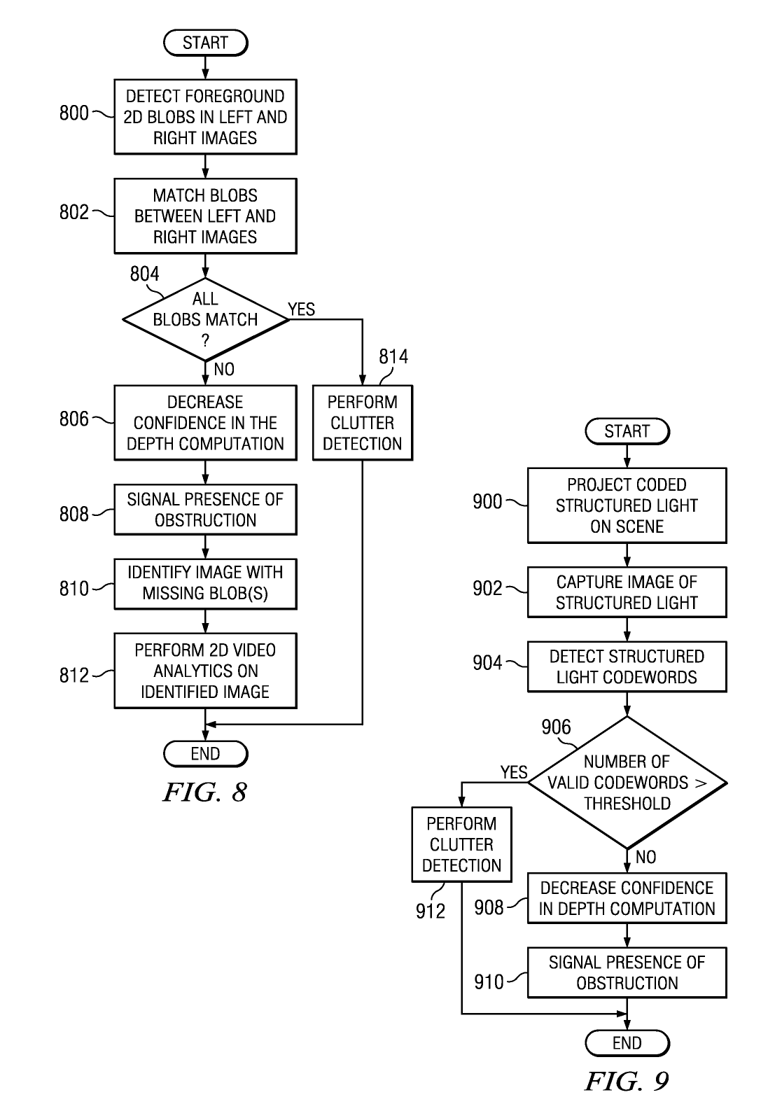

Further, in some embodiments, the surveillance network 300 includes functionality to perform a method for obstruction detection as described herein as well as a method for clutter elimination. Methods for obstruction detection are described in more detail herein in reference to FIGS. 8 and 9. The obstruction detection may be performed in a suitably configured surveillance camera, or in a suitably configured computer in the surveillance center 312 that is receiving encoded video sequence from the surveillance camera or in the computer 310. The obstruction detection may also be provided by a system (not specifically shown) connected to a surveillance camera that provides the encoding and/or transmission of video sequences captured by the surveillance camera.

The surveillance center 312 includes one or more computer systems and other equipment for receiving and displaying the video sequences captured by the surveillance cameras communicatively coupled to the surveillance center 312. The computer systems may be monitored by security personnel and at least one of the computer systems may be configured to generate audible and/or visual alarms in response to specified events detected through analysis of the images in the video sequence. In some embodiments, a computer system receiving a video sequence from a surveillance camera may be configured to respond to alarms by calling security personnel, sending a text message or the like, or otherwise transmitting an indication of the alarm to security personnel.

The computer 310 is configured to receive video sequence(s) from one or more video surveillance cameras. Such a combination of a computer and one or more video surveillance cameras may be used, for example, in a home security system, a security system for a small business, etc. Similar to computers in a surveillance center, the computer 310 may be configured to generate audible and/or visual alarms in response to the detection of specified events and/or notify a security monitoring service or the home/business owner via a text message, a phone call, or the like when an alarm is signaled.

FIG. 4 is a block diagram of an example digital video depth camera 400 that may be used for surveillance, e.g., in the surveillance network of FIG. 3. The depth camera 400 includes a 3D imaging system 402, an image and depth processing component 404, a video encoder component 418, a memory component 410, a video analytics component 412, a camera controller 414, and a network interface 416. The components of the depth camera 400 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Further, software instructions may be stored in memory in the memory component 410 and executed by one or more processors.

The 3D imaging system 402 includes two imaging components 406, 408 and a controller component 412 for capturing the data needed to generate a depth image. The imaging components 406, 408 and the functionality of the controller component 412 vary depending on the 3D imaging technology implemented. For example, for a stereoscopic camera, the imaging components 406, 408 are imaging sensor systems arranged to capture image signals of a scene from a left viewpoint and a right viewpoint. That is, one imaging sensor system 406 is arranged to capture an image signal from the left viewpoint, i.e., a left analog image signal, and the other imaging sensor system 408 is arranged to capture an image signal from the right view point, i.e., a right analog image signal. Each of the imaging sensor subsystems 406, 408 includes a lens assembly, a lens actuator, an aperture, and an imaging sensor. The 3D imaging system 402 also includes circuitry for controlling various aspects of the operation of the system, such as, for example, aperture opening amount, exposure time, etc. The controller module 412 includes functionality to convey control information from the camera controller 414 to the imaging sensor systems 406, 408, to convert the left and right analog image signals to left and right digital image signals, and to provide the left and right digital image signals to the image and depth processing component 404.

For a TOF camera or a structured light camera, the imaging component 406 is an imaging sensor system arranged to capture image signals of a scene as previously described and the imaging component 408 is an illumination unit arranged to project light, e.g., infrared light, into the scene. The imaging sensor system 406 may also include an optical filter that matches the optical frequency of the light projected by the illumination unit 408. The 3D imaging system 402 also includes circuitry for controlling various aspects of the operation of the system, such as, for example, aperture opening amount, exposure time, synchronization of the imaging sensor system 406 and the illumination unit 408, etc. In a TOF camera, each pixel captured by the imaging sensor system 406 measures the time the light from the illumination unit 408 to surfaces in the scene and back. In a structured light camera, the pixels captured by the imaging sensor system 406 capture the deformation on surfaces in the scene of a pattern of light projected by the illumination unit 408. The controller module 412 includes functionality to convey control information from the camera controller 414 to the imaging sensor system 406 and the illumination unit 408, to convert the image signals from the imaging sensor system 406 to digital image signals, and to provide the digital image signals to the image and depth processing component 404.

The image and depth processing component 404 divides the incoming digital signal(s) into frames of pixels and processes each frame to enhance the image data in the frame. The processing performed may include one or more image enhancement techniques according to imaging technology used to capture the pixel data. For example, for stereoscopic imaging, the image and depth processing component 404 may perform one or more of black clamping, fault pixel correction, color filter array (CFA) interpolation, gamma correction, white balancing, color space conversion, edge enhancement, denoising, contrast enhancement, detection of the quality of the lens focus for auto focusing, and detection of average scene brightness for auto exposure adjustment on each of the left and right images. The same enhancement techniques may also be applied to the images captured by a structured light camera. Enhancement techniques for images captured by a TOF camera may include faulty pixel correction and denoising.

The image and depth processing component 404 then uses the enhanced image data to generate a depth image. Any suitable algorithm may be used to generate the depth image from the enhanced image data. The depth images are provided to the video encoder component 408 and the video analytics component 412. If the camera 400 is a stereoscopic camera, the left and right 2D images are also provided to the video analytics component 412 and the video encoder component 408. If a structured light or TOF camera includes a human-viewable imaging sensor, the 2D image from that sensor is also provided to the video analytics component 412 and the video encoder component 408.

The video encoder component 408 encodes the images in accordance with a video compression standard such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), the ITU-T/ISO High Efficiency Video Coding (HEVC) standard, etc.

The memory component 410 may be on-chip memory, external memory, or a combination thereof. Any suitable memory design may be used. For example, the memory component 410 may include static random access memory (SRAM), dynamic random access memory (DRAM), synchronous DRAM (SDRAM), read-only memory (ROM), flash memory, a combination thereof, or the like. Various components in the digital video camera 400 may store information in memory in the memory component 410 as a video stream is processed. For example, the video encoder component 408 may store reference data in a memory of the memory component 410 for use in encoding frames in the video stream. Further, the memory component 410 may store any software instructions that are executed by one or more processors (not shown) to perform some or all of the described functionality of the various components.

Some or all of the software instructions may be initially stored in a computer-readable medium such as a compact disc (CD), a diskette, a tape, a file, memory, or any other computer readable storage device and loaded and stored on the digital video camera 400. In some cases, the software instructions may also be sold in a computer program product, which includes the computer-readable medium and packaging materials for the computer-readable medium. In some cases, the software instructions may be distributed to the digital video camera 400 via removable computer readable media (e.g., floppy disk, optical disk, flash memory, USB key), via a transmission path from computer readable media on another computer system (e.g., a server), etc.

The camera controller component 414 controls the overall functioning of the digital video camera 400. For example, the camera controller component 414 may adjust the focus and/or exposure of the 3D imaging system 402 based on the focus quality and scene brightness, respectively, determined by the image and depth processing component 404. The camera controller component 414 also controls the transmission of the encoded video stream via the network interface component 416 and may control reception and response to camera control information received via the network interface component 416. Further, the camera controller component 414 controls the transfer of alarms and other information from the video analytics component 412 via the network interface component 416.

The network interface component 416 allows the digital video camera 400 to communicate with a monitoring system. The network interface component 416 may provide an interface for a wired connection, e.g., an Ethernet cable or the like, and/or for a wireless connection. The network interface component 416 may use any suitable network protocol(s).

The video analytics component 412 analyzes the content of images in the captured video stream to detect and determine temporal events not based on a single image. The analysis capabilities of the video analytics component 412 may vary in embodiments depending on such factors as the processing capability of the digital video camera 400, the particular application for which the digital video camera is being used, etc. For example, the analysis capabilities may range from video motion detection in which motion is detected with respect to a fixed background model to people counting, detection of objects crossing lines or areas of interest, vehicle license plate recognition, object tracking, facial recognition, automatically analyzing and tagging suspicious objects in a scene, activating alarms or taking other actions to alert security personnel, etc. As part of the analysis of the content of images, the video analytics component 412 performs a method for clutter elimination as described herein. Further, if the digital video camera 400 is a stereoscopic camera or a structured light camera, the video analytics component 412 also performs a method for obstruction detection as described herein.

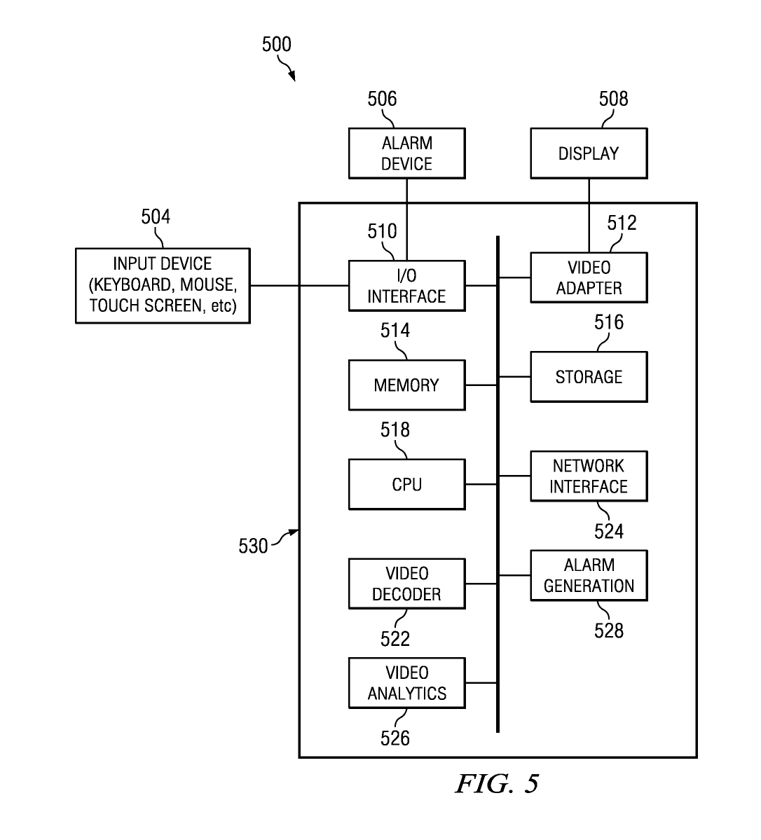

FIG. 5 is a block diagram of a computer system 500. The computer system 500 may be used in a surveillance network as, for example, the computer system 310 or as a computer system in the surveillance center 312. The computer system 500 includes a processing unit 530 equipped with one or more input devices 504 (e.g., a mouse, a keyboard, or the like), and one or more output devices, such as a display 508, or the like. In some embodiments, the computer system 500 also includes an alarm device 506. In some embodiments, the display 508 may be touch screen, thus allowing the display 508 to also function as an input device. The processing unit 530 may be, for example, a desktop computer, a workstation, a laptop computer, a dedicated unit customized for a particular application, or the like. The display may be any suitable visual display unit such as, for example, a computer monitor, an LED, LCD, or plasma display, a television, a high definition television, or a combination thereof.

The processing unit 530 includes a central processing unit (CPU) 518, memory 514, a storage device 516, a video adapter 512, an I/O interface 510, a video decoder 522, and a network interface 524 connected to a bus. In some embodiments, the processing unit 530 may include one or more of a video analytics component 526 and an alarm generation component 528 connected to the bus. The bus may be one or more of any type of several bus architectures including a memory bus or memory controller, a peripheral bus, video bus, or the like.

The CPU 518 may be any type of electronic data processor. For example, the CPU 518 may be a processor from Intel Corp., a processor from Advanced Micro Devices, Inc., a Reduced Instruction Set Computer (RISC), an Application-Specific Integrated Circuit (ASIC), or the like. The memory 514 may be any type of system memory such as static random access memory (SRAM), dynamic random access memory (DRAM), synchronous DRAM (SDRAM), read-only memory (ROM), flash memory, a combination thereof, or the like. Further, the memory 514 may include ROM for use at boot-up, and DRAM for data storage for use while executing programs.

The storage device 516 (e.g., a computer readable medium) may comprise any type of storage device configured to store data, programs, and other information and to make the data, programs, and other information accessible via the bus. In one or more embodiments, the storage device 516 stores software instructions that, when executed by the CPU 518, cause the processing unit 530 to monitor one or more digital video cameras being used for surveillance. The storage device 516 may be, for example, one or more of a hard disk drive, a magnetic disk drive, an optical disk drive, or the like.

The software instructions may be initially stored in a computer-readable medium such as a compact disc (CD), a diskette, a tape, a file, memory, or any other computer readable storage device and loaded and executed by the CPU 518. In some cases, the software instructions may also be sold in a computer program product, which includes the computer-readable medium and packaging materials for the computer-readable medium. In some cases, the software instructions may be distributed to the computer system 500 via removable computer readable media (e.g., floppy disk, optical disk, flash memory, USB key), via a transmission path from computer readable media on another computer system (e.g., a server), etc.

The video adapter 512 and the I/O interface 510 provide interfaces to couple external input and output devices to the processing unit 530. As illustrated in FIG. 5, examples of input and output devices include the display 508 coupled to the video adapter 512 and the mouse/keyboard 504 and the alarm device 506 coupled to the I/O interface 510.

The network interface 524 allows the processing unit 530 to communicate with remote units via a network (not shown). In one or more embodiments, the network interface 524 allows the computer system 500 to communicate via a network to one or more digital video cameras to receive encoded video sequences and other information transmitted by the digital video camera(s). The network interface 524 may provide an interface for a wired link, such as an Ethernet cable or the like, and/or a wireless link via, for example, a local area network (LAN), a wide area network (WAN) such as the Internet, a cellular network, any other similar type of network and/or any combination thereof.

The computer system 510 may also include other components not specifically shown. For example, the computer system 510 may include power supplies, cables, a motherboard, removable storage media, cases, and the like.

The video decoder component 522 decodes frames in an encoded video sequence received from a digital video camera in accordance with a video compression standard such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), the ITU-T/ISO High Efficiency Video Coding (HEVC) standard, etc. The decoded frames may be provided to the video adapter 512 for display on the display 508. In embodiments including the video analytics component 526, the video decoder component 522 also provides the decoded frames to this component.

The video analytics component 526 analyzes the content of frames of the decoded video stream to detect and determine temporal events not based on a single frame. The analysis capabilities of the video analytics component 526 may vary in embodiments depending on such factors as the processing capability of the processing unit 530, the processing capability of digital video cameras transmitting encoded video sequences to the computer system 500, the particular application for which the digital video cameras are being used, etc. For example, the analysis capabilities may range from video motion detection in which motion is detected with respect to a fixed background model to people counting, detection of objects crossing lines or areas of interest, vehicle license plate recognition, object tracking, facial recognition, automatically analyzing and tagging suspicious objects in a scene, activating alarms or taking other actions to alert security personnel, etc. As part of the analysis of the content of images, the video analytics component 526 may perform a method for clutter elimination as described herein. Further, the video analytics component 526 may also perform a method for obstruction detection as described herein.

The alarm generation component 528 may receive alarm data from a video camera via the network interface 524 and/or the video analytics component 526 and performs actions to notify monitoring personnel of the alarms. For example, if the digital video camera performs a method for clutter elimination as described herein, the camera may transmit alarm data to the computer system 500 indicating that clutter was detected and eliminated. Further, if the digital video camera performs a method for obstruction detection as described herein, the camera may transmit alarm data to the computer system 500 indicating compromised camera integrity. The actions to be taken may be user-configurable and may differ according to the type of the alarm signal. For example, the alarm generation component 528 may cause a visual cue to be displayed on the display 508 for less critical alarms and may generate an audio and/or visual alarm via the alarm device 506 for more critical alarms. The alarm generation component 528 may also cause notifications of alarms to be sent to monitoring personnel via email, a text message, a phone call, etc.

FIG. 6 is a flow diagram of a method for clutter elimination in a depth image. The method may be performed in a digital video depth camera and/or in a system receiving video sequences from a digital video depth camera. The method may be performed on each depth image. Initially, foreground blobs are detected in the depth image 600. Any suitable technique for detecting foreground blobs may be used. In general, to detect foreground blobs, background subtraction is performed between the depth image and a depth background model of the scene under observation to generate a binary mask image. Morphological operations such as dilation and erosion may then be performed on the binary image to eliminate isolated pixels and small regions. Connected components analysis is then perform to extract individual blobs, i.e., sets of foreground pixels connected in the binary image. Some suitable techniques for detecting foreground blobs in a depth image are described in C. Eveland, et al., “Background Modeling for Segmentation of Video-Rate Stereo Sequences,” IEEE Computer Vision and Pattern Recognition, pp. 266-271, June 1998; M. Harville, et al., “Foreground Segmentation Using Adaptive Mixture Models in Color and Depth,” IEEE Workshop on Detection and Recognition of Events in Video, pp. 3-11, July 2001; and J. Salas and C. Tomasi, “People Detection Using Color and Depth Images,” Mexican Conference on Pattern Recognition, pp. 127-135, June 2011.

Then, each detected blob is processed 602-608. The depth of the blob is computed based on the depths of one or more pixels included in the blob 602. Any suitable technique for determining the depth of a blob from one or more values of pixels in a depth image may be used. The computed depth is indicative of the distance from the camera of the object in the scene corresponding to the blob. If the depth of the blob is not greater than a depth threshold 604, the blob is marked as clutter 606. Otherwise, the next blob, if any 608, is processed.

After all the blobs are processed, analysis of the image continues as per the particular application for which the video depth camera is being used. How the marked blobs are handled is application dependent. For example, some applications may ignore any blobs that are marked as clutter. Other applications may generate an alarm indicating that clutter was detected. Other applications may generate an alarm if clutter is detected over some configurable number of images.

The depth threshold may be a predetermined value and/or may be user defined. The value of the depth threshold may be set by the operator of a system receiving video sequence from a video depth camera. Further, if the method is performed in the video depth camera, the depth threshold value set by the operator may be communicated to the video depth camera.

FIG. 7 is a flow diagram of a method for clutter elimination in a depth image when a depth camera also captures human-viewable 2D images of the scene in addition to the depth image. The method may be performed for both the left 2D image and the right 2D image of a stereoscopic image. The method may be performed in a digital video depth camera and/or in a system receiving video sequences from a digital video depth camera. The method may be performed for each depth image.

Initially, foreground blobs are detected in a 2D image 700. Any suitable technique for detecting foreground blobs in a 2D image may be used. Then, each detected blob is processed 702-712. Relevant features of a detected blob such as appearance, shape, and velocity are extracted 702. The features that are extracted, i.e., the relevant features, depend on the characteristics of objects that are important in the particular application for which the stereoscopic video camera is being used. The extracted features are then used to determine if the blob is sufficiently similar to an important object 704. For example, if people and vehicles are important objects to an application, the blob shape and velocity may be compared to expected shapes and velocities of blobs corresponding to people and vehicles. For example, vertically oriented rectangle-shaped blobs are more likely to be people than vehicles. Similarly, horizontally oriented objects are more likely to be vehicles. More complex appearance features such as distributions of color and gradient information are also often used. Such features are typically analyzed by a classifier that is used to determine if the features belong to an object of interest. In general, the analysis performed should be strict in the sense that only blobs that can be determined with a high degree of confidence as belonging to an object of interest are allowed to pass this stage. Otherwise, a blob that is actually clutter may pass this test.

If the blob is determined to be sufficiently similar to an expected object 704, processing continues with the next identified blob, if any 712. Otherwise, the depth of the blob is computed based on the depths of one or more pixels corresponding to the blob in the depth image 706. Any suitable technique for determining the depth of a blob from one or more values of pixels in a depth image may be used. The computed depth is indicative of the distance from the camera of the object in the scene corresponding to the blob. If the depth of the blob is greater than a depth threshold 708, the next blob, if any 712, is processed. Otherwise, the blob is marked as clutter 710 and processing continues with the next blob, if any 712.

After all the blobs are processed, analysis of the depth image and 2D image(s) continues as per the particular application for which the stereoscopic video camera is being used. How the marked blobs are handled is application dependent. For example, some applications may ignore any blobs that are marked as clutter. Other applications may generate an alarm indicating that clutter was detected. Other applications may generate an alarm if clutter is detected over some configurable number of images.

The depth threshold may be a predetermined value and/or may be user defined. The value of the depth threshold may be set by the operator of a system receiving video sequence from a video depth camera. Further, if the method is performed in the video depth camera, the depth threshold value set by the operator may be communicated to the stereoscopic video camera.

FIG. 8 is a flow diagram of a method for obstruction detection in a stereoscopic image. This method relies on the stereoscopic camera having two lenses separated by a small distance, which makes it highly unlikely that identical clutter will occur on or near both lenses at the same time. The method may be performed in a stereoscopic video camera and/or in a system receiving video sequences from a stereoscopic video camera. The method may be performed on each stereoscopic image.

Initially, foreground blobs are identified in the left image and the right image of the stereoscopic image 800. Any suitable technique for detecting foreground blobs in a 2D image may be used. The identified blobs are then matched between the left and right images 802. Any suitable techniques for determining blob matches may be used. If all the blobs match 804, clutter detection may optionally be performed on the stereoscopic image 814. For example, clutter detection may be performed on each of the left and right images as per steps 702-712 of FIG. 7. Or, clutter detection may be performed using the depth image of the stereoscopic image as per the method of FIG. 6.

If all of the blobs do not match 804, then the confidence in the depth computation for the stereoscopic image is decreased 806, and presence of an obstruction is signaled 808. The image with the missing blob(s) is then identified 810 and 2D video analytics are performed on the identified image 812. The 2D analysis performed depends on the particular application for which the stereoscopic video camera is being used.

FIG. 9 is a flow diagram of a method for obstruction detection in a depth image captured by a structured light camera. Similar to FIG. 8, this method relies on the structured light camera having the imaging lens and the light projector separated by a small distance, which makes it highly unlikely that identical clutter will occur on or near both the lens and the projector at the same time. The method may be performed in the camera and/or in a system receiving video sequences from the camera. In structured light cameras where there are more than one camera lens and sensor combinations, the method may be performed on each image captured by the camera.

Initially, coded structured light is projected onto the scene such that each pixel in the projected pattern has a unique codeword 900. The reflection of the structured light from the scene is imaged by each of the lens and sensor combinations in the camera 902. The image is then analyzed to recover the codewords corresponding to the known projected pattern 904. If the number of valid detected codewords is greater than a threshold 906, optional clutter detection may be performed on the computed depth image 912, as per the method of FIG. 6.

If the number of valid codewords is lower than the threshold 906, then the confidence in the depth computation of the current frame is decreased 908 and the presence of an obstruction is signaled 910. This method is capable of detecting obstruction of either the projecting element, or of any of the imaging elements on the camera.

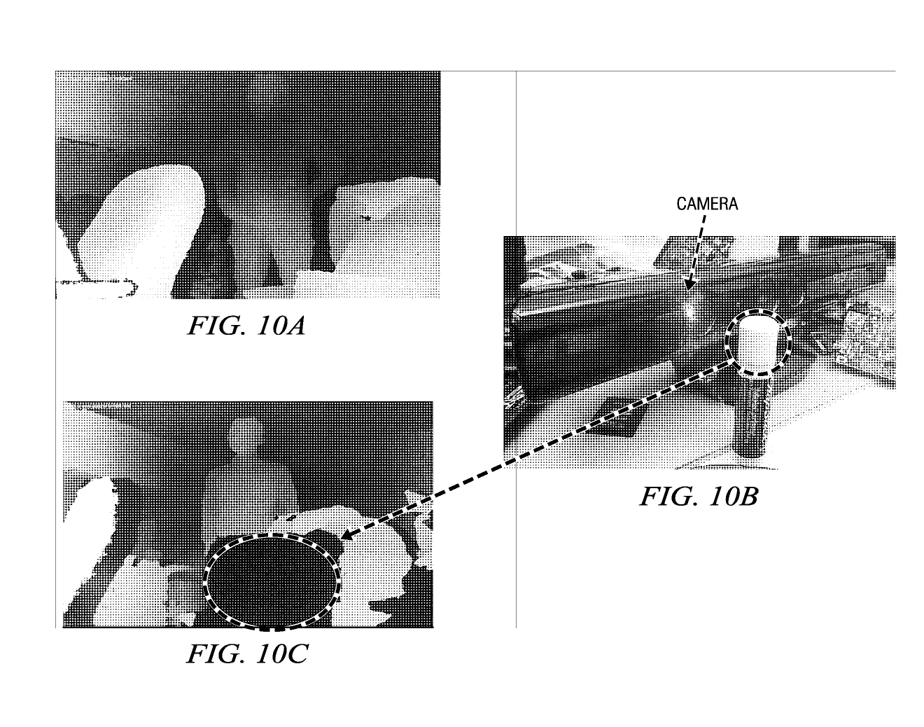

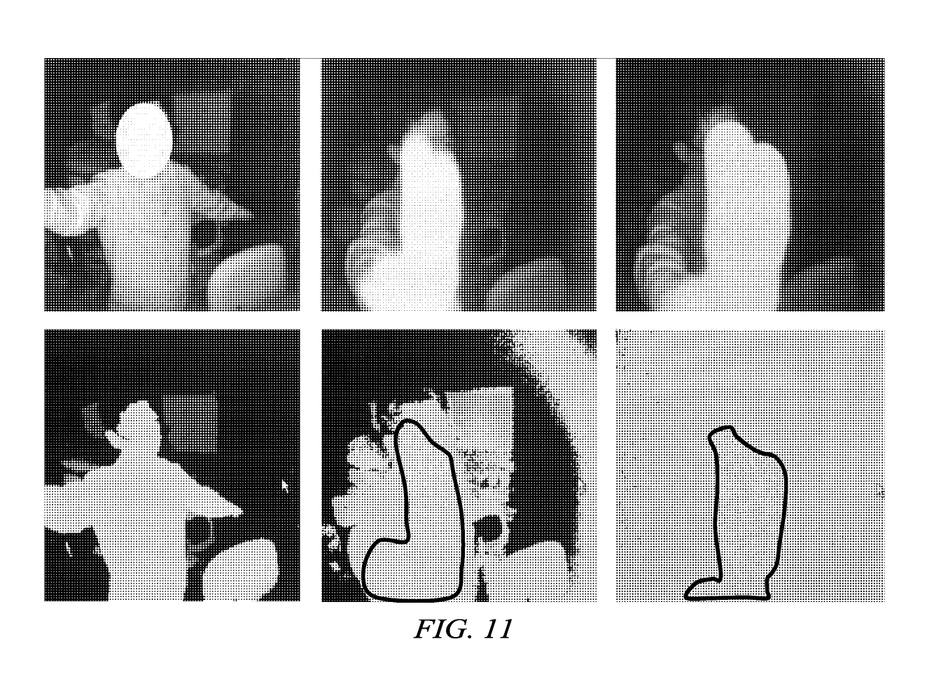

FIGS. 10A-10C show an example of how obstructing the projector on a structured light camera affects the computed scene depth. FIG. 10A shows a depth image from an unobstructed camera. FIG. 10B shows the presence of an obstruction, i.e., clutter, in front of the projector of the camera. FIG. 10C shows the corresponding hole in the resulting depth image. The method of FIG. 9 will be able to signal the presence of an obstruction in cases similar to this provided the extent of obstruction passes the set threshold.

FIG. 11 shows an example of a foreground blob appearing close to the sensor of a time-of-flight camera. In this sequence of time-of-flight depth images, a person is gradually moving two fingers closer to the camera. The foreground blob corresponding to the person's fingers is outlined in bold. From the sequence of depth images, it can be seen that the depth of the highlighted blob is smaller than the rest of the scene. The method of FIG. 6 will signal the presence of lens blockage in such scenarios.

### Other Embodiments

While the invention has been described with respect to a limited number of embodiments, those skilled in the art, having benefit of this disclosure, will appreciate that other embodiments can be devised which do not depart from the scope of the invention as disclosed herein.

Embodiments of the methods described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

It is therefore contemplated that the appended claims will cover any such modifications of the embodiments as fall within the true scope of the invention.

What is claimed is:

1. A method of clutter elimination in digital images, the method comprising:
identifying a foreground blob in an image;
determining a depth of the foreground blob; and
indicating that the foreground blob is clutter when the depth indicates that the foreground blob is too close to be an object of interest.

2. The method of claim 1, wherein indicating that the foreground blob is clutter comprises comparing the depth to a depth threshold.

3. The method of claim 1, further comprising:
performing the determining a depth and the indicating responsive to determining that at least one feature of the foreground blob is not similar to an expected feature of an object of interest.

4. The method of claim 3, wherein the image is a two-dimensional (2D) image and the determining of a depth is performed using a depth image.

5. The method of claim 1, wherein image is a depth image and determining a depth is performed using the depth image.

6. The method of claim 1, wherein
the image is a first 2D image of a stereoscopic image; and
the determining a depth and the indicating are performed responsive to determining that the foreground blob matches a foreground blob identified in a second 2D image of the stereoscopic image.

7. The method of claim 6, further comprising:
determining that the foreground blob does not match any blob in the second 2D image;
signaling presence of an obstruction;
decreasing confidence in depth computation for the stereoscopic image; and
performing 2D video analytics on the second 2D image.

8. The method of claim 1, further comprising:
analyzing the image to recover codewords corresponding to a projected light pattern, and performing the identifying, the determining a depth and the indicating responsive to determining that sufficient valid codewords corresponding to the light pattern were recovered.

9. The method of claim 8, wherein determining that sufficient valid codewords corresponding to the light pattern were recovered comprises comparing a number of valid codewords to a threshold.

10. The method of claim 8, further comprising signaling presence of an obstruction when the number of valid codewords recovered is not sufficient.

11. A method of analyzing a stereoscopic image, the method comprising:
identifying foreground blobs in a first two-dimensional (2D) image and a second 2D image of the stereoscopic image;
matching foreground blobs between the first 2D image and the second 2D image; and
signaling an obstruction when a foreground blob in the first 2D image does not match any foreground blob in the second 2D image.

12. The method of claim 11, further comprising:
performing 2D video analytics on the second 2D image when a foreground blob in the first 2D image does not match any foreground blob in the second 2D image.

13. The method of claim 11, further comprising:
performing clutter detection on the stereoscopic image when all foreground blobs match.

14. The method of claim 11, wherein performing clutter detection comprises:
determining a depth of a foreground blob; and
indicating that the foreground blob is clutter when the depth indicates that the foreground blob is too close to be an object of interest.

15. The method of claim 14, wherein indicating that the foreground blob is clutter comprises comparing the depth to a depth threshold.

16. The method of claim 14, further comprising:
performing the determining a depth and the indicating that the foreground blob is clutter responsive to determining that at least one feature of the foreground blob is not similar to an expected feature of an object of interest.

17. A method of analyzing a depth image captured using a projected light pattern, the method comprising:
analyzing the depth image to recover valid codewords corresponding to the projected light pattern;
determining if a sufficient number of valid codewords was recovered; and
signaling presence of an obstruction when the number of recovered valid codewords is insufficient.

18. The method of claim 17, wherein determining if a sufficient number of valid codewords was recovered comprises comparing a number of valid codewords to a threshold.

19. The method of claim 17, further comprising performing clutter detection on the depth image when a sufficient number of valid codewords was recovered, wherein the clutter detection comprises:
identifying a foreground blob;
determining a depth of the foreground blob; and
indicating that the foreground blob is clutter when the depth indicates that the foreground blob is too close to be an object of interest.

20. The method of claim 19, wherein indicating that the foreground blob is clutter comprises comparing the depth to a depth threshold.
